(19) United States
(12) Patent Application Publication
(10) Pub. No.: US 2007/0263813 A1
(43) Pub. Date: Nov. 15, 2007

(54) Communication device and method for avoiding deadlock of a terminal device

(75) Inventor: Chu-Feng Lien, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,873

(22) Filed: Oct. 16, 2006

(30) Foreign Application Priority Data
Mar. 17, 2006 (TW) 095109187

(51) Int. Cl. H04M 3/42

(52) U.S. Cl. 379/201.01

(57) ABSTRACT

A communication device (30) for avoiding deadlock of a terminal device, includes a transceiver module (300), a timer module (310), and a network module (320). The transceiver module receives a communication termination signal from a local exchange (LE) and generates a timing signal. The timer module receives the timing signal to start timing. The network module includes a time processing sub-module (321), a signal determining sub-module (322), and a signal sending sub-module (323). The time processing sub-module sends a query signal to the terminal device for querying a state of the terminal device after the timer module has timed out. The signal determining sub-module receives a state signal and determining whether the state signal includes a communication completion state, and if the state signal includes a communication completion state, sending it. The signal sending sub-module receives the communication completion signal, and sends to the LE via the transceiver module.

### FIELD OF THE INVENTION

The invention relates to communication devices, and particularly to a communication device for avoiding deadlock of a terminal device.

### DESCRIPTION OF RELATED ART

With development of communication networks, more and more subscribers use the public switched telephone network (PSTN). If the PSTN is busy, signals such as on-hook signals, may be lost. In a typical communication network, when a first subscriber and a second subscriber are on-hook, the first subscriber and the second subscriber both send an on-hook signal to a local exchange (LE). If the on-hook signal of the first subscriber is lost, and though the LE only receives the on-hook signal of the second subscriber, the LE treats the first subscriber as still being in communication with the LE. If a third subscriber wants to communicate with the first subscriber, because the LE shows that the first subscriber is still communicating, the third subscriber can not connect to the first subscriber unless the LE receives the on-hook signal of the first subscriber. If the LE always misses the on-hook signals of the first subscriber, deadlock of the first subscriber will occur.

### SUMMARY OF THE INVENTION

An exemplary embodiment of the invention provides a communication device for avoiding deadlock of a terminal device. The communication device includes a transceiver module, a timer module, and a network module. The transceiver module is connected to the local exchange (LE), and is used for receiving a communication termination signal from the LE and generating a timing signal. The timer module is connected to the transceiver module, and is used for receiving the timing signal to start timing. The network module is connected to the transceiver module, and includes a time processing sub-module, a signal determining sub-module, and a signal sending sub-module. The time processing sub-module is connected to the timer module, and is used for sending a query signal to the terminal device for querying a state of the terminal device after the timer module has timed out. The signal determining sub-module is connected to the terminal device, and is used for receiving a state signal from the terminal device, determining whether the state signal includes a communication completion state, and if the state signal includes a communication completion state, sending the communication completion signal. The signal sending sub-module is connected to the signal determining sub-module, and is used for receiving the communication completion signal and sending the communication completion signal to the LE via the transceiver module.

Another exemplary embodiment of the invention provides a method for avoiding deadlock of a terminal device. The method includes receiving a communication termination signal from a local exchange (LE), generating a timing signal, and sending the timing signal; receiving the timing signal to start timing; sending a query signal to the terminal device for querying a state of the terminal device after the timer module has timed out; receiving a state signal from the terminal device, and determining whether the state signal includes a communication completion state; and sending the communication completion signal to the LE, if the state signal is the communication completing signal.

Other advantages and novel features will become more apparent from the following detailed description when taken in conjunction with the accompanying drawings, in which:

### BRIEF DESCRIPTION OF THE DRAWINGS

FIG. 1 is a diagram of an application environment of a communication device in accordance with an exemplary embodiment of the present invention;

FIG. 2 is a block diagram of the communication device of FIG. 1; and

FIG. 3 is a flow chart of a method for avoiding deadlock of a terminal device of another exemplary embodiment of the present invention.

### DETAILED DESCRIPTION OF THE INVENTION

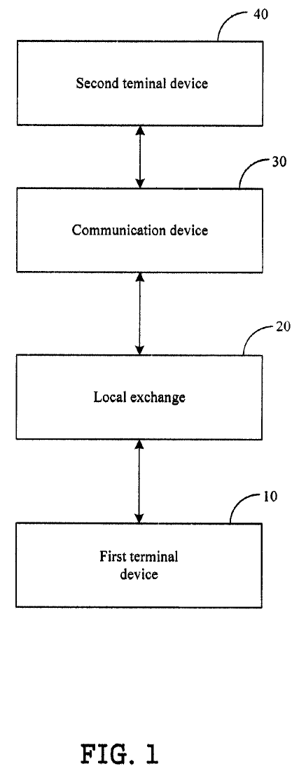

FIG. 1 is a diagram of an application environment of a communication device 30 of an exemplary embodiment of the invention. In the exemplary embodiment, a first terminal device 10 communicates with a second terminal device 40 via a local exchange (LE) 20 and the communication device 30. In the exemplary embodiment, the first terminal device 10 and the second terminal device 40 may be public switched telephone network (PSTN) terminal devices, such as telephones. The communication device 30 may be an access network device or an access point (AP). After completing communication with the second terminal device 40, the first terminal device 10 sends a state-indicating signal, such as a communication completion signal, to the LE 20, and the LE 20 sends a communication termination signal to the communication device 30. In the exemplary embodiment, the state-indicating signal, i.e., the communication completion signal, may be an on-hook signal, and the communication termination signal may be a disconnect pulse polarity reverse signal.

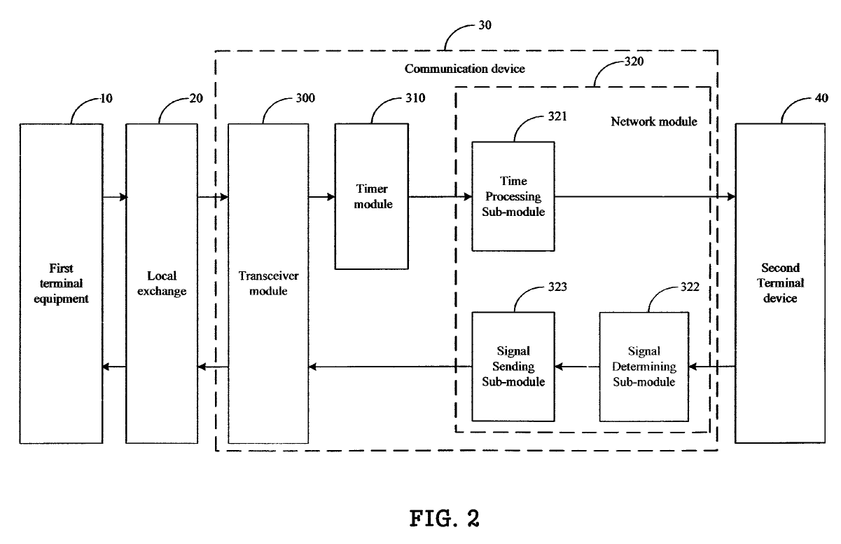

FIG. 2 is a block diagram of the communication device 30 of an exemplary embodiment of the invention. In the exemplary embodiment, the communication device 30 includes a transceiver module 300, a timer module 310, and a network module 320. The transceiver module 300 is connected to the LE 20, and is used for receiving the communication termination signal from the LE 20 and generating a timing signal. The timer module 310 is connected to the transceiver module 300, and is used for receiving the timing signal to start timing during a predetermined time period. In the exemplary embodiment, a timing period of the timer module 310 may be set to 20 seconds. If the communication device 30 receives a communication completion signal from the second terminal device 40 during the timing period, the timer module 310 stops timing, and the communication device 30 will send the communication completion signal to the LE 20.

In the exemplary embodiment, the network module 320 is connected to the transceiver module 300, and includes a time processing sub-module 321, a signal determining sub-module 322, and a signal sending sub-module 323. The time processing sub-module 321 is connected to the second terminal device 40 and the timer module 310, and is used for sending a query signal to the second terminal device 40 for querying a state of the second terminal device 40 after the timer module 310 has timed out. In the exemplary embodiment, if the communication device 30 does not receives the communication completion signal from the second terminal device 40 after the timer module has timed out, the time processing sub-module 321 sends the query signal to the second terminal device 40 for querying the state of the second terminal device 40.

The second terminal device 40 receives the query signal from the time processing sub-module 321, and sends a state signal corresponding to the query signal to the signal determining sub-module 322.

The signal determining sub-module 322 is connected to the second terminal device 40, and used for receiving the state signal and determining whether the state signal includes a communication completion state. In the exemplary embodiment, the signal determining sub-module 322 sends a communication completion signal to the signal sending module 323; otherwise, if the state signal does not include the communication completion state, the signal determining sub-module 322 does nothing. The signal sending sub-module 323 is connected to the signal determining sub-module 322, and is used for receiving the communication completion signal from the signal determining sub-module 322 and sending the communication completion signal to the transceiver module 300. The transceiver module 300 is connected between the signal sending sub-module 323 and the LE 20, and is further used for receiving the communication completion signal from the signal sending sub-module 323, and sending the communication completion signal to the LE 20. After the LE 20 receives the communication completion signal, the LE 20 switches a communication state of the second terminal device 40 into an idle state for waiting for a new communication.

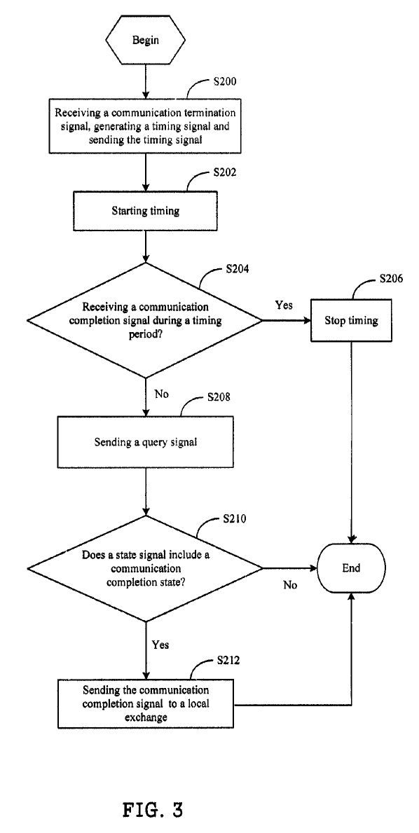

FIG. 3 is a flow chart of a method for avoiding deadlock of a terminal device. In the exemplary embodiment, the method is for avoiding deadlock of the second terminal device 40. After the first terminal device 10 completes communication with the second terminal device 40, the LE 20 firstly receives a communication completion signal from the first terminal device 10, generates a communication termination signal, and sends the communication termination signal to the communication device 30. In step S200, the transceiver module 300 receives the communication termination signal from the LE 20, generates a timing signal, and sends the timing signal to the timer module 310. In step S202, the timer module 310 receives the timing signal, and starts timing. In the exemplary embodiment, the timing period of the timer module is set to 20 seconds.

In step S204, the timer module 310 determines whether the communication device 30 receives a communication completion signal from the second terminal device 40 during the timing period. In step S206, if the communication device 30 receives the communication completion signal from the second terminal device 40 during the timing period, the timer module 310 stops timing. Otherwise, in step S208, if the communication device 30 does not receive the communication completion signal from the second terminal device 40 during the timing period, the time processing sub-module 321 sends a query signal to the second terminal device 40 for querying a state of the second terminal device 40 after the timer module 310 has timed out. The second terminal device 40 sends a state signal to the communication device 30 according to the query signal.

In step 210, the signal determining sub-module 322 receives the state signal from the second terminal device 40, and determines whether the state signal includes a communication completion state. In step S212, if the state signal includes the communication completion state, the communication device 30 sends the communication completion signal to the LE 20. In the process of the step S212, the signal determining sub-module 322 first sends the communication completion signal to the signal sending sub-module 323. Then the signal sending sub-module 323 receives the communication completion signal from the signal determining sub-module 322, and sends the communication completion signal to the LE 20 via the transceiver module 300. If the state signal does not include the communication completion state, the signal determining sub-module 322 does nothing, and the process ends. After the LE 20 receives the communication completion signal, the LE 20 switches a communication state of the second terminal device 40 into an idle state for waiting for a new communication.

Alternatively, the above-mentioned method can also be applicable in any communication device which needs to receive a particular signal in time to avoid any deadlock. The possible deadlock can be easily avoided because timely query signals will be sent to urge retrieval of the particular signal.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A communication device for avoiding deadlock of a terminal device, comprising:
a transceiver module connected to a local exchange (LE), for receiving a communication termination signal from the LE and generating a timing signal;
a timer module connected to the transceiver module, for receiving the timing signal to start timing during a predetermined time period; and
a network module connected to the timer module and the transceiver module, comprising:
a time processing sub-module connected to the timer module, for sending a query signal to the terminal device for querying a state of the terminal device after the timer module has timed out;
a signal determining sub-module connected to the terminal device, for receiving a state signal from the terminal device and determining whether the state signal comprises a communication completion state, and if the state signal comprises a communication completion state, sending a communication completion signal; and
a signal sending sub-module connected to the signal determining sub-module and the transceiver module, for receiving the communication completion signal from the signal determining sub-module and sending the communication completion signal to the LE via the transceiver module.

2. The communication device of claim 1, wherein the communication device comprises an access network device.

3. The communication device of claim 1, wherein the communication termination signal comprises a disconnect pulse polarity reverse signal.

4. The communication device of claim 1, wherein the communication completion signal comprises an on-hook signal.

5. The communication device of claim 1, wherein the predetermined time period is 20 seconds.

6. A method for avoiding deadlock of a terminal device, comprising:
receiving a communication termination signal from a local exchange (LE), generating a timing signal and sending the timing signal;
after the timing signal is sent to a timer module, starting timing during a predetermined time period;
sending a query signal to the terminal device for querying a state of the terminal device after timing out;
receiving a state signal from the terminal device and determining whether the state signal comprises a communication completion state; and
sending a communication completion signal to the LE, if the state signal is the communication completion state.

7. The method for avoiding deadlock of a terminal device of claim 6, wherein the communication termination signal comprises a disconnect pulse polarity reverse signal.

8. The method for avoiding deadlock of a terminal device of claim 6, wherein the communication completion signal comprises an on-hook signal.

9. The method for avoiding deadlock of a terminal device of claim 6, wherein the predetermined time period comprises 20 seconds.

10. The method for avoiding deadlock of a terminal device of claim 6, further comprising:
determining whether the communication device receives the communication completion signal from the terminal device during the time period.

11. The method for avoiding deadlock of a terminal device of claim 10, further comprising:
if the communication device receives the communication completion signal from the terminal device, stopping timing.

12. The method for avoiding deadlock of a terminal device of claim 6, wherein the step of sending the communication completion signal to the LE comprising:
sending the communication completion signal to a signal sending sub-module; and
receiving the communication completion signal, and sending the communication completion signal to the LE via a transceiver module.

13. A method for avoiding deadlock of a terminal device, comprising the steps of:
establishing signal communication between a terminal device and a communication device;
starting timing in said communication device for a predetermined time period;
stop said timing when a state-indicating signal, used to indicate a current state of said terminal device and sent from said terminal device to said communication device, is received by said communication device during said timing for said predetermined time period; and
sending a query signal from said communication device to said terminal device to query said current state of said terminal device when said state-indicating signal is not available to be sent from said terminal device to said communication device after said timing for said predetermined time period expires.

14. The method of claim 13, further comprising the step of receiving a communication termination signal from a local exchange (LE) signally communicable with said communication device in order to start said timing.

15. The method of claim 13, wherein said state-indicating signal indicates a communication completion state detectable out of a state signal sent from said terminal device to said communication device.
